(19) United States
(12) Patent Application Publication
(10) Pub. No.: US 2026/0127031 A1
(43) Pub. Date: May 7, 2026

(54) SYSTEM AND METHOD FOR DIGITAL RESOURCE ALLOCATION VIA AN INTERACTIVE COMPUTATIONAL FRAMEWORK

(71) Applicant: BANK OF AMERICA CORPORATION, Charlotte, NC (US)

(72) Inventors: Pratap Dande, Saint Johns, FL (US); Tony Aidoo, Aubrey, TX (US); Noell Y. Eury, Stanfield, NC (US); Brian Neal Jacobson, Granada Hills, CA (US); Dennis Vranjesevic, Kent Cliffs, NY (US); Rahul Yaksh, Austin, TX (US); Bojan Zdravkovic, Jersey City, NJ (US)

(73) Assignee: BANK OF AMERICA CORPORATION, Charlotte, NC (US)

(21) Appl. No.: 18/935,857

(22) Filed: Nov. 4, 2024

(51) Int. Cl. G06F 9/50; G06F 21/31; H04L 9/00

(52) U.S. Cl. CPC G06F 9/5005; G06F 21/31; H04L 9/50

(57) ABSTRACT

Systems, computer program products, and methods are described herein for digital resource allocation via an interactive computational framework. The present disclosure includes receiving credentials at a first endpoint device, authenticating the credentials, receiving a digital resource allocation request from the first endpoint device, the digital resource allocation request comprising parameters of a user associated with the authenticated credentials and item parameters of an item associated with the digital resource allocation request, retrieving user data associated with the user, determining, using a machine learning model, a digital resource allocation proposal based on the user data, generating, using a generative AI model, based on the digital resource allocation proposal, a smart contract comprising ownership, appending the smart contract to a distributed ledger, and transferring digital resources according to the smart contract.

### TECHNOLOGICAL FIELD

Example implementations of the present disclosure relate to a system and method for digital resource allocation via an interactive computational framework.

### BACKGROUND

In the context of vehicle acquisition, systems facilitate the process through resource allocation or usage-based agreements. Existing vehicle acquisition methods often rely on predefined models that fail to account for dynamic variables such as changing conditions related to vehicle operation. Usage agreements are typically based on static limits and predetermined structures, without adjusting for actual vehicle utilization. The data used in these processes is often manually input, leading to inefficiencies. Furthermore, generalized assumptions are applied to estimate vehicle depreciation, resulting in inaccurate projections of residual value. Coverage requirements are imposed according to fixed parameters, which may lead to unnecessary costs despite use of the vehicle. These challenges highlight the need for a system and method for digital resource allocation via an interactive computational framework.

### BRIEF SUMMARY

Systems, methods, and computer program products are provided for digital resource allocation via an interactive computational framework.

In one aspect, a system for digital resource allocation via an interactive computational framework is presented. The system may include a processing device, and a non-transitory storage device containing instructions, when executed by the processing device, the instructions cause the processing device to perform the steps of receiving credentials at a first endpoint device, authenticating the credentials, receiving a digital resource allocation request from the first endpoint device, the digital resource allocation request including parameters of a user associated with the authenticated credentials and item parameters of an item associated with the digital resource allocation request, retrieving user data associated with the user, determining, using a machine learning model, a digital resource allocation proposal based on the user data, generating, using a generative AI model, based on the digital resource allocation proposal, a smart contract including ownership, appending the smart contract to a distributed ledger, and transferring digital resources according to the smart contract.

In some implementations, the instructions may further cause the processing device to perform the steps of generating, by using the item parameters provided to the generative AI model, a maintenance schedule and corresponding event data for the item, transmitting the event data to the first endpoint device, receiving, at a predetermined interval, telemetry data from the item, amending, based on the telemetry data, the maintenance schedule and the corresponding event data, and transmitting, after amending, the maintenance schedule and the event data to the first endpoint device.

In some implementations, the instructions may further cause the processing device to perform the steps of receiving, at the first endpoint device, an input including a query, processing, via the generative AI model, the input to identify one or more keywords associated with the query, wherein the generative AI model is trained on natural language data, the smart contract, and the parameters of the user, querying, via an API call upon a condition where the input includes a maintenance inquiry, a database including the event data, generating, using the generative AI model, a response to the input, and causing to display on the first endpoint device the response.

In some implementations, the user data associated with the user includes parameters of the user selected from a group consisting of the user data including social media marketplace activity, user account data, employment history from a background check API, and collateral value assessment.

In some implementations, the digital resource allocation proposal based on the user data includes a digital resource allocation amount, rate, and time period.

In some implementations, the smart contract further includes maintenance records.

In some implementations, the smart contract further includes an accident history.

In another aspect, a computer program product for digital resource allocation via an interactive computational framework is presented. The computer program product may include a non-transitory computer-readable medium including code causing an apparatus to receive credentials at a first endpoint device, authenticate the credentials, receive a digital resource allocation request from the first endpoint device, the digital resource allocation request including parameters of a user associated with the authenticated credentials and item parameters of an item associated with the digital resource allocation request, retrieve user data associated with the user, determine, using a machine learning model, a digital resource allocation proposal based on the user data, generate, using a generative AI model, based on the digital resource allocation proposal, a smart contract including ownership, append the smart contract to a distributed ledger, and transfer digital resources according to the smart contract.

In some implementations, the code may further cause the apparatus to generate, by using the item parameters provided to the generative AI model, a maintenance schedule and corresponding event data for the item, transmit the event data to the first endpoint device, receive, at a predetermined interval, telemetry data from the item, amend, based on the telemetry data, the maintenance schedule and the corresponding event data, and transmit, after amending, the maintenance schedule and the event data to the first endpoint device.

In some implementations, the code may further cause the apparatus to receive, at the first endpoint device, an input including a query, process, via the generative AI model, the input to identify one or more keywords associated with the query, wherein the generative AI model is trained on natural language data, the smart contract, and the parameters of the user, query, via an API call upon a condition where the input includes a maintenance inquiry, a database including the event data, generate, using the generative AI model, a response to the input, and cause to display on the first endpoint device the response.

In some implementations, the user data associated with the user includes parameters of the user selected from a group consisting of the user data including social media marketplace activity, user account data, employment history from a background check API, and collateral value assessment.

In some implementations, the digital resource allocation proposal based on the user data includes a digital resource allocation amount, rate, and time period.

In some implementations, the smart contract further includes maintenance records.

In some implementations, the smart contract further includes an accident history.

In yet another aspect, a method for digital resource allocation via an interactive computational framework is presented. The method may include receiving credentials at a first endpoint device, authenticating the credentials, receiving a digital resource allocation request from the first endpoint device, the digital resource allocation request including parameters of a user associated with the authenticated credentials and item parameters of an item associated with the digital resource allocation request, retrieving user data associated with the user, determining, using a machine learning model, a digital resource allocation proposal based on the user data, generating, using a generative AI model, based on the digital resource allocation proposal, a smart contract including ownership, appending the smart contract to a distributed ledger, and transferring digital resources according to the smart contract.

In some implementations, the method may further include generating, by using the item parameters provided to the generative AI model, a maintenance schedule and corresponding event data for the item, transmitting the event data to the first endpoint device, receiving, at a predetermined interval, telemetry data from the item, amending, based on the telemetry data, the maintenance schedule and the corresponding event data, and transmitting, after amending, the maintenance schedule and the event data to the first endpoint device.

In some implementations, the method may further include receiving, at the first endpoint device, an input including a query, processing, via the generative AI model, the input to identify one or more keywords associated with the query, wherein the generative AI model is trained on natural language data, the smart contract, and the parameters of the user, querying, via an API call upon a condition where the input includes a maintenance inquiry, a database including the event data, generating, using the generative AI model, a response to the input, and causing to display on the first endpoint device the response.

In some implementations, the user data associated with the user includes parameters of the user selected from a group consisting of the user data including social media marketplace activity, user account data, employment history from a background check API, and collateral value assessment.

In some implementations, the digital resource allocation proposal based on the user data includes a digital resource allocation amount, rate, and time period.

In some implementations, the smart contract further includes maintenance records.

The above summary is provided merely for purposes of summarizing some example implementations to provide a basic understanding of some aspects of the present disclosure. Accordingly, it will be appreciated that the above-described implementations are merely examples and should not be construed to narrow the scope or spirit of the disclosure in any way. It will be appreciated that the scope of the present disclosure encompasses many potential implementations in addition to those here summarized, some of which will be further described below.

### BRIEF DESCRIPTION OF THE DRAWINGS

Having thus described implementations of the disclosure in general terms, reference will now be made the accompanying drawings. The components illustrated in the Figures may or may not be present in certain implementations described herein. Some implementations may include fewer (or more) components than those shown in the Figures.

FIGS. 1A-1C illustrate technical components of an exemplary distributed computing environment for digital resource allocation via an interactive computational framework, in accordance with an implementation of the disclosure;

FIG. 2 illustrates an exemplary machine learning model subsystem architecture, in accordance with an implementation of the disclosure;

FIG. 3 illustrates an exemplary generative AI model subsystem, in accordance with an implementation of the disclosure;

FIGS. 4A-4B illustrate an exemplary distributed ledger technology (DLT) architecture, in accordance with an implementation of the disclosure; and

FIGS. 5A-5C illustrate a process flow for digital resource allocation via an interactive computational framework, in accordance with an implementation of the disclosure.

### DETAILED DESCRIPTION

Implementations of the present disclosure will now be described more fully hereinafter with reference to the accompanying drawings, in which some, but not all, implementations of the disclosure are shown. Indeed, the disclosure may be implemented in many different forms and should not be construed as limited to the implementations set forth herein; rather, these implementations are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the entity, its products or applications, the customers or any other aspect of the operations of the entity. As such, the entity may be any institution, group, association, institution, establishment, company, union, authority or the like, employing information technology resources for processing large amounts of data.

As described herein, a “user” may be an individual associated with an entity. As such, in some implementations, the user may be an individual having past relationships, current relationships or potential future relationships with an entity. In some implementations, the user may be an employee (e.g., an associate, a project manager, an IT specialist, a manager, an administrator, an internal operations analyst, or the like) of the entity or enterprises affiliated with the entity.

As used herein, a “user interface” or “display” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some implementations, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system. In some implementations, an engine may implement a machine learning model to perform functions as a foundation for the larger piece of software that drives the functionality of the software. The machine learning model for any given engine may be self-contained (e.g., without interaction with other engines), or the machine learning model may be shared across one or more engines. In other words, some implementations of the larger piece of software many implement multiple machine learning models to perform functions of the various engines. In other implementations, a single machine learning model may be shared across one or more engines to perform the functions attributed thereto as described herein.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that an element matches a predetermined criterion, including that a threshold has been met, passed, exceeded, and so on.

The technical problem involves the inefficiency and inconsistency in data-driven decision-making processes within the auto financing ecosystem. Specifically, the systems used by lenders rely on static, credit-based scoring models that fail to account for a comprehensive set of financial and behavioral data inputs, leading to inaccurate entity vulnerability assessments and inflated interest rates for certain consumers. The approval workflow for auto loans and leases is bottlenecked by manual verifications of financial and collateral information, increasing processing time and reducing system throughput. Furthermore, the lack of integrated data processing mechanisms to monitor vehicle depreciation in real-time results in consumers unknowingly entering negative equity positions, affecting their ability to trade in or refinance vehicles efficiently. Additionally, the calculation and application of payments, such as documentation, processing, early termination, and mileage excess usage costs, are executed through static rule-based algorithms, which do not dynamically adapt to changes in consumer behavior or market conditions, leading to unexpected financial burdens for the end user.

Current technological implementations lack advanced data modeling and adaptive learning capabilities, which limits their ability to mitigate these inefficiencies. Loan and lease systems predominantly use fixed, linear credit-scoring algorithms that ignore more dynamic financial and behavioral datasets (e.g., transaction history, spending patterns, employment status, and vehicle usage data), resulting in suboptimal interest rate calculations. Automated approval processes are not fully integrated with real-time data feeds, requiring multiple manual checkpoints that delay loan processing and introduce human error. In terms of payment assessment, static computational models do not leverage machine learning algorithms to predict and adjust payments dynamically based on historical data patterns or real-time consumer behaviors, leading to unexpected costs for the user. Furthermore, current solutions lack real-time depreciation tracking algorithms that could recalibrate loan or lease terms, leaving consumers vulnerable to negative equity situations. The absence of adaptive insurance compliance algorithms results in excessive insurance costs for consumers, as systems fail to optimize insurance requirements based on individualized entity vulnerability assessments.

Addressing these challenges requires the establishment of a system and method for digital resource allocation via an interactive computational framework, which provides for the use of a allocation request portal on an endpoint device that implements a machine learning-based evaluation of a user that looks beyond just financial reliability scores and evaluates user data to result in a holistic allocation proposal, which, upon acceptance of the allocation proposal may result in a smart contract being recorded in a distributed ledger to provide for traceability and prevent unwanted tampering. Based on the item underlying the allocation proposal, if accepted, a maintenance schedule for the item may be generated and automatically updated based on the usage of the item. Moreover, a portal may be provided to allow for a user to engage with a generative AI model to determine the status of the digital resource allocation, maintenance of the item, or the like.

To do so, credentials associated with a user may be received and authenticated. Thereafter, a digital resource allocation (i.e., loan or lease) request may be received, which may include parameters of the user and item. User data may then be retrieved, which may include social media marketplace activity, user account data, employment history from a background check API, collateral value assessment, or the like. Using this user data, a machine learning model may determine a digital resource allocation proposal. The digital resource allocation proposal may also include a digital resource allocation amount, rate, a time period, or the like. A generative AI model may then generate a smart contract based on the digital allocation proposal, if accepted by the user. The smart contract may then be appended to a distributed ledger, whereafter, digital resources may be transferred according to the smart contract. In some implementations, the generative AI model may generate, by using the item parameters, a maintenance schedule and corresponding event data (e.g., calendar invites, invitations, etc.), which may be transmitted to the endpoint device. Telemetry data from the item may be received at a predetermined interval, and based on the telemetry data, the maintenance data and event data may be altered to better suit the use of the item. In some implementations, the portal at the endpoint device may provide for receiving an input (e.g., a query), which may then be processed using the generative AI model having been trained on natural language data, the smart contract, and the parameters of the user. If the input is a maintenance inquiry, this may include querying a database including the event data. The generative AI model may then generate a response to the input.

What is more, the present disclosure provides a technical solution to a technical problem. As described herein, the technical problem includes the lack of dynamic, real-time data integration and adaptive algorithms in auto financing systems, leading to inefficient interest rate calculations, delayed approval processes, inaccurate equity assessments, and rigid payment structures. The present disclosure embraces an improvement over existing solutions by allowing for the generation of digital resource allocation requests, approvals, recording, and underlying item maintenance and inquiries (i) with fewer steps to achieve the solution (e.g., implementing a machine learning model to determine aspects of the item allocation), thus reducing the amount of network resources, such as processing resources, storage resources, network resources, and/or the like, that are being used, (ii) providing a more accurate solution to problem, thus reducing the number of resources required to remedy any errors made due to a less accurate solution (e.g., generating the smart contact using generative AI to avoid errors in drafting a standard contract), (iii) removing manual input and waste from the implementation of the solution, thus improving speed and efficiency of the process and conserving network resources (e.g., automatically scheduling maintenance on the underlying item based on the use of the item), (iv) determining an optimal amount of resources that need to be used to implement the solution, thus reducing network traffic and load on existing network resources. In other words, the solution may bypass a series of steps previously implemented, thus further conserving network resources. Furthermore, the technical solution described herein uses a rigorous, computerized process to perform specific tasks and/or activities that were not previously performed.

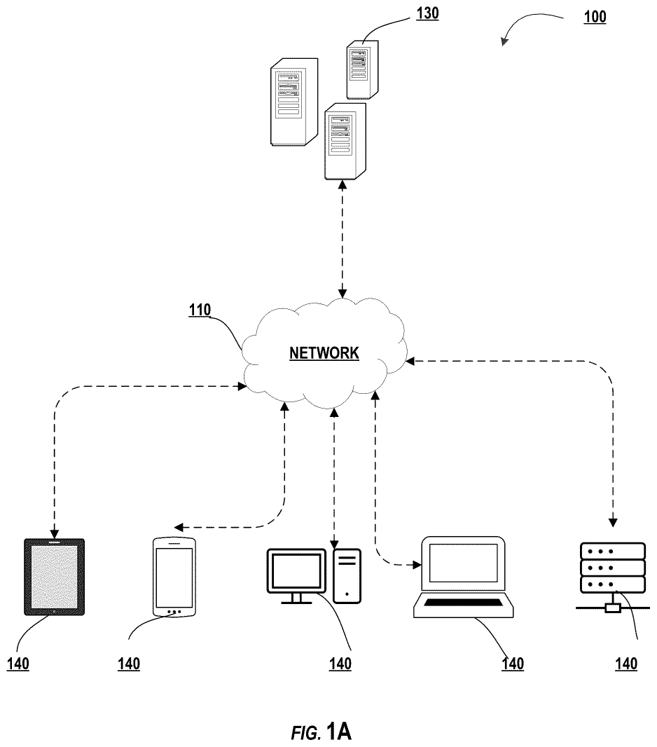

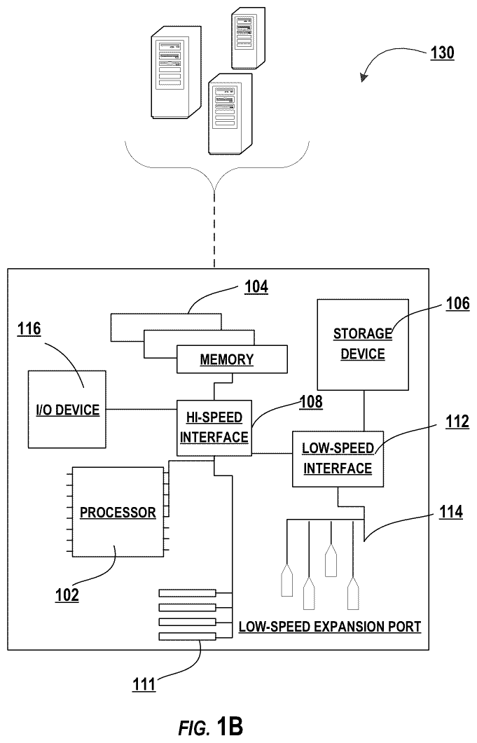

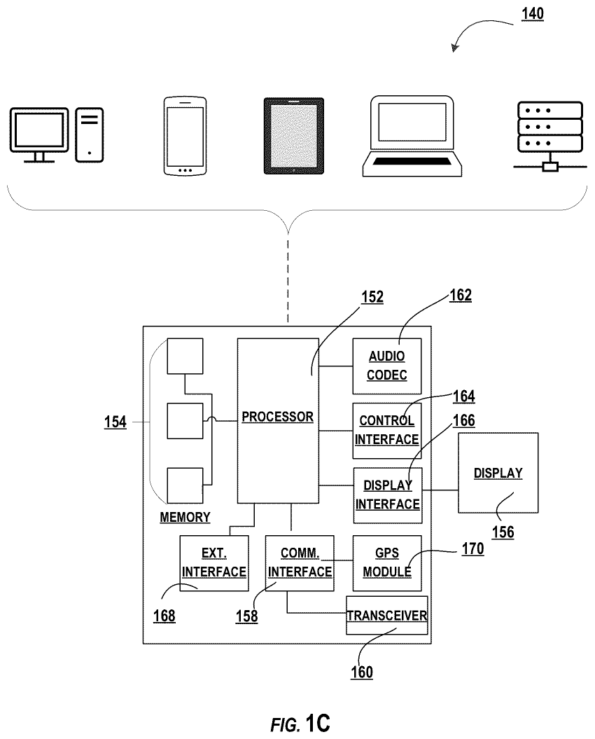

FIGS. 1A-1C illustrate technical components of an exemplary distributed computing environment 100 for digital resource allocation via an interactive computational framework, in accordance with an implementation of the disclosure. As shown in FIG. 1A, the distributed computing environment 100 contemplated herein may include a system 130, an endpoint device(s) 140, and a network 110 over which the system 130 and endpoint device(s) 140 communicate therebetween. FIG. 1A illustrates only one example of an implementation of the distributed computing environment 100, and it will be appreciated that in other implementations one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some implementations, the system 130 and the endpoint device(s) 140 may have a client-server relationship in which the endpoint device(s) 140 are remote devices that request and receive application from a centralized server, i.e., the system 130. In some other implementations, the system 130 and the endpoint device(s) 140 may have a peer-to-peer relationship in which the system 130 and the endpoint device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The endpoint device(s) 140 may represent various forms of electronic devices, including user input devices such as personal digital assistants, cellular telephones, smartphones, laptops, desktops, and/or the like, input devices such as resource transfer terminals, electronic resource transfer units, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. In addition to shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an implementation of the disclosure. As shown in FIG. 1B, the system 130 may include a processing device 102, memory 104, input/output (I/O) device 116, and a storage device 106. The system 130 may also include a high-speed interface 108 connecting to the memory 104, and a low-speed interface 112 connecting to a low-speed bus 114 and a storage device 106. Each of the components 102, 104, 108, 110, and 112 may be operatively coupled to one another using various buses and may be mounted on a common motherboard or in other manners as appropriate. As described herein, the processing device 102 may include a number of subsystems to execute the portions of processes described herein. Each subsystem may be a self-contained component of a larger system (e.g., system 130) and capable of being configured to execute specialized processes as part of the larger system.

The processing device 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processing devices, along with multiple memories, and/or I/O devices, to execute the processes described herein. In other words, as used herein, a “processing device” means one processing device (e.g., a microprocessor) that performs the defined functions or a plurality of processing devices (e.g., microprocessors) that collectively perform defined functions such that the execution of the individual defined functions may be divided amongst such processing devices.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly implemented in an information carrier. The computer program product may also contain instructions that, when executed, perform one or more methods, such as those described above. The information carrier may be a non-transitory computer-or machine-readable storage medium, such as the memory 104, the storage device 106, or memory on processing device 102.

The high-speed interface 108 manages bandwidth-intensive operations for the system 130, while the low-speed controller 112 manages lower bandwidth-intensive operations. Such allocation of functions is exemplary only. In some implementations, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the endpoint device(s) 140, in accordance with an implementation of the disclosure. As shown in FIG. 1C, the endpoint device(s) 140 includes a processing device 152, memory 154, an input/output device such as a display 156, a communication interface 158, and a transceiver 160, among other components. The endpoint device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processing device 152 is configured to execute instructions within the endpoint device(s) 140, including instructions stored in the memory 154, which in one implementation includes the instructions of an application that may perform the functions disclosed herein, including certain logic, data processing, and data storing functions. The processing device may be implemented as a chipset of chips that include separate and multiple analog and digital processors. The processing device may be configured to provide, for example, for coordination of the other components of the endpoint device(s) 140, such as control of user interfaces, applications run by endpoint device(s) 140, and wireless communication by endpoint device(s) 140.

The processing device 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processing device 152. In addition, an external interface 168 may be provided in communication with processing device 152, so as to enable near area communication of endpoint device(s) 140 with other devices. External interface 168 may provide, for example, for wired communication in some implementations, or for wireless communication in other implementations, and multiple interfaces may also be used.

The memory 154 stores information within the endpoint device(s) 140. The memory 154 can be implemented as one or more of a computer-readable medium or media, a volatile memory unit or units, or a non-volatile memory unit or units. Expansion memory may also be provided and connected to endpoint device(s) 140 through an expansion interface (not shown), which may include, for example, a SIMM (Single In Line Memory Module) card interface. Such expansion memory may provide extra storage space for endpoint device(s) 140 or may also store applications or other information therein. In some implementations, expansion memory may include instructions to carry out or supplement the processes described above and may include secure information also. For example, expansion memory may be provided as a security module for endpoint device(s) 140 and may be programmed with instructions that permit secure use of endpoint device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly implemented in an information carrier. The computer program product contains instructions that, when executed, perform one or more methods, such as those described herein. The information carrier is a computer-or machine-readable medium, such as the memory 154, expansion memory, memory on processing device 152, or a propagated signal that may be received, for example, over transceiver 160 or external interface 168.

In some implementations, the user may use the endpoint device(s) 140 to transmit and/or receive information or commands to and from the system 130 via the network 110. Any communication between the system 130 and the endpoint device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the endpoint device(s) 140 may provide the system 130 (or other client devices) permissioned access to the protected resources of the endpoint device(s) 140, which may include a GPS device, an image capturing component (e.g., camera), a microphone, and/or a speaker.

The endpoint device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to endpoint device(s) 140, which may be used as appropriate by applications running thereon, and in some implementations, one or more applications operating on the system 130.

The endpoint device(s) 140 may also communicate audibly using audio codec 162, which may receive spoken information from a user and convert the spoken information to usable digital information. Audio codec 162 may likewise generate audible sound for a user, such as through a speaker, e.g., in a handset of endpoint device(s) 140. Such sound may include sound from voice telephone calls, may include recorded sound (e.g., voice messages, music files, etc.) and may also include sound generated by one or more applications operating on the endpoint device(s) 140, and in some implementations, one or more applications operating on the system 130.

Various implementations of the distributed computing environment 100, including the system 130 and endpoint device(s) 140, and techniques described here can be realized in digital electronic circuitry, integrated circuitry, specially designed ASICs (application specific integrated circuits), computer hardware, firmware, software, and/or combinations thereof.

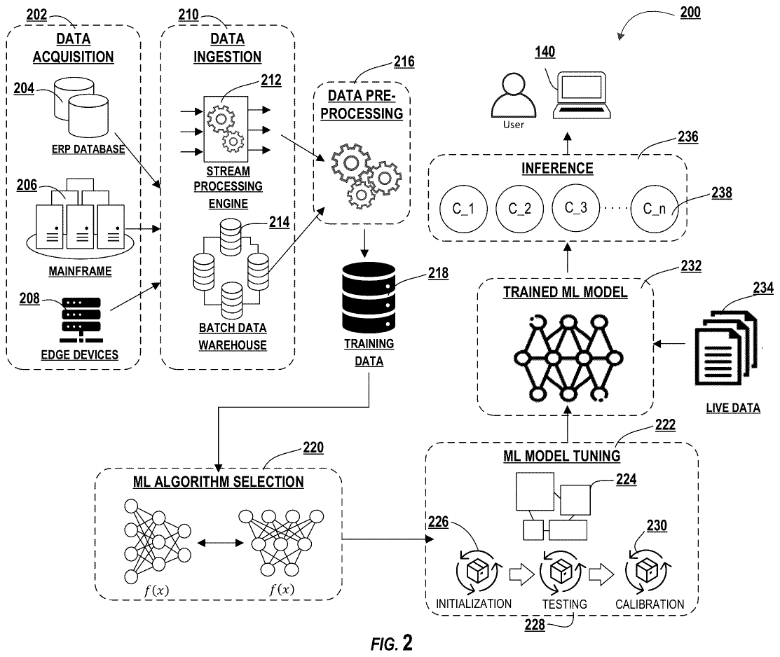

FIG. 2 illustrates an exemplary machine learning model subsystem architecture 200, in accordance with an implementation of the disclosure. The machine learning subsystem 200 may include a data acquisition engine 202, data ingestion engine 210, data pre-processing engine 316, machine learning model tuning engine 222, and inference engine 236.

The data acquisition engine 202 may identify various internal and/or external data sources to generate, test, and/or integrate new features for training the machine learning model. These internal and/or external data sources 204, 206, and 208 may be initial locations where the data originates or where physical information is first digitized. The data acquisition engine 202 may identify the location of the data and describe connection characteristics for access and retrieval of data. In some implementations, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other applications. In some implementations, the these data sources 204, 206, and 208 may include Enterprise Resource Planning (ERP) databases or protocol databases that host data related to day-to-day enterprise activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of network resources to process. Feature extraction and/or selection may be used to select and /r combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points. As will be understood in view of the present disclosure, training data 218 may additionally, or alternatively, be provided from a third party, having been generated as synthetic data.

The machine learning model tuning engine 222 may be used to train a machine learning model to form a trained machine learning model 232 using the training data 218 to make predictions or decisions without explicitly being programmed to do so. The machine learning model 232 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms can adjust their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the machine learning model, the machine learning model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the machine learning model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized.

The trained machine learning model 232, similar to any other software application output, can be persisted to storage, file, memory, or application, or looped back into the processing component to be reprocessed. More often, the trained machine learning model 232 is deployed into an existing production environment to make practical enterprise decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It shall be understood that the implementation of the machine learning subsystem 200 illustrated in FIG. 2 is exemplary and that other implementations may vary. As another example, in some implementations, the machine learning subsystem 200 may include more, fewer, or different components.

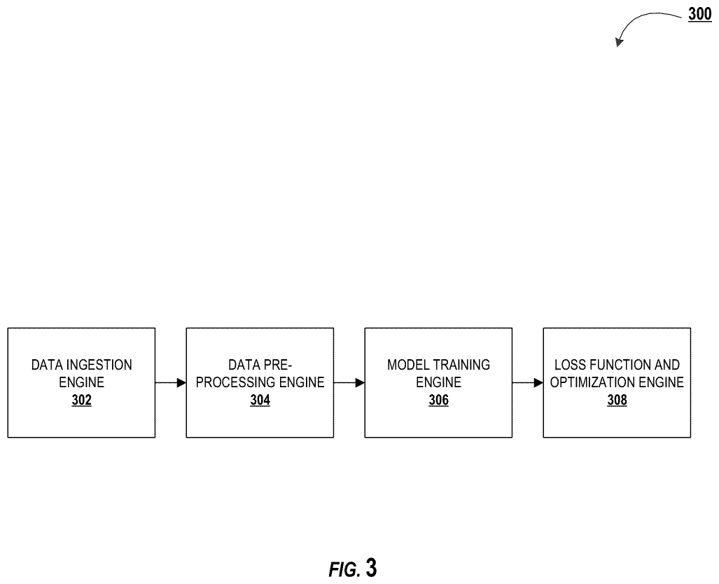

FIG. 3 illustrates an exemplary generative AI subsystem 300, in accordance with an implementation of the disclosure. The generative AI subsystem 300 may include a data ingestion engine 302, a data pre-processing engine 304, a model training engine 306, and a loss function and optimization engine 308. It should be understood that the generative AI subsystem 300 is merely an example, and other implementations may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 300 should not be considered limiting and may be adapted to various configurations within the scope of the disclosure.

The data ingestion engine 302 may identify various internal and/or external data sources to generate, test, and/or integrate new features for training the generative AI model. These internal and/or external data sources (e.g., text corpora, web-based text data, document repositories, or decentralized text storage system) may be initial locations where the data originates or where physical information is first digitized. In addition to conventional data sources, the data ingestion engine 302 may support decentralized storage systems, such as blockchain-based data sources, and privacy-preserving methods such as differential privacy. The data ingestion engine 302 may identify the location of the data and describe connection characteristics for access and retrieval of data. In some implementations, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some implementations, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 302 may move the data to a destination for storage or further analysis. Typically, the data may be in varying formats as they come from different sources, including RDBMS, other types of databases, S3 buckets, CSVs, or from streams. For a large language model (“LLM”), text data may originate from sources such as web scrapes, social media, large public text datasets, or the like. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In machine learning, the quality of data and the useful information that can be derived therefrom directly affects the ability of the machine learning model to learn. The data pre-processing engine 304 may implement advanced integration and processing steps needed to prepare the data for machine learning execution, including tokenization, text normalization, and removal of irrelevant elements like HTML tags in web-based data, especially for LLM training. This may include modules to perform any upfront, data transformation to consolidate the data into alternate forms by changing the value, structure, or format of the data using generalization, normalization, attribute selection, and aggregation, text-specific transformations such as stemming and lemmatization, data cleaning by filling missing values, smoothing the noisy data, resolving the inconsistency, and removing outliers, and/or any other encoding steps as needed. In some implementations, the data pre-processing engine 304 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 304 may transform categorical data into numerical formats that are suitable for machine learning algorithms. In this regard, the data pre-processing engine 304 may use techniques such as one-hot encoding or label encoding depending on the nature of the categorical variables and the intended use of the data.

In some implementations, the data pre-processing engine 304 may also include dimensionality reduction techniques, where the number of input features is reduced while retaining the most relevant information. In this regard, the data pre-processing engine 304 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 304 may then be fed into the model training module 306.

The model training engine 306 may be responsible for training the generative AI models using the pre-processed data from the data pre-processing engine 304. The model training engine 306 may implement various machine learning algorithms, including but not limited to Generative Adversarial Networks (GANs), Variational Autoencoders (VAEs), transformers, diffusion models, or other specialized architectures depending on the specific requirements of the system. These models may be used in a broad range of applications, such as LLMs for text generation, image generation models, video synthesis models, audio generation models, and/or the like. The model training engine 306 may optimize these models by continuously adjusting their internal parameters based on the patterns and relationships identified within the data.

In some implementations, the model training engine 306 may include a training data handler, which manages the partitioning of the pre-processed data into training, validation, and testing datasets. The training data is used to update the model's parameters, while the validation and testing datasets are reserved to evaluate the model's performance during and after training. The model training engine 306 may support various data-handling strategies, such as cross-validation or random shuffling, to ensure that the model generalizes well and is not overfitting to the training data.

In implementations involving large language models, the model training engine 306 may utilize transformer-based architectures, such as the Transformer, BERT, GPT, or the like. Transformer models rely on mechanisms like self-attention to capture dependencies between words in a sequence, regardless of their distance from one another. The self-attention mechanism allows the model to weigh the importance of different words in a sentence and establish complex relationships important for understanding context. During training, the model may process vast amounts of text data and learn to predict the next word or token in a sequence based on the input context. This training process allows LLMs to generate coherent text, complete sentences, translate languages, or answer questions based on learned patterns from the data.

The transformer-based LLMs may be trained using autoregressive (e.g., GPT) or masked-language modeling techniques (e.g., BERT). In autoregressive models, the training process may include predicting the next word in a sequence by progressively revealing more context to the model. The model iteratively improves its predictions based on its performance during prior iterations. Masked-language modeling involves masking certain words in a sentence and training the model to correctly predict the masked words based on surrounding context. Both approaches enable LLMs to capture intricate patterns in human language, improving their ability to handle tasks such as summarization, translation, and text generation. Loss functions like cross-entropy loss may be used to optimize the model's performance by comparing predicted tokens with the actual tokens in the dataset to guide the model to minimize prediction errors during training.

In implementations involving image generation models, the model training engine 306 may utilize transformer-based architectures, such as Vision Transformers (ViTs) or generative adversarial networks (GANs). Vision Transformers rely on self-attention mechanisms to process images as sequences of patches rather than whole images, allowing the model to capture spatial dependencies and patterns across the image. During training, the model may be exposed to large datasets containing diverse image types to learn features like textures, edges, and shapes. The model may then generate or reconstruct images by interpreting these patterns and applying learned spatial relationships. GAN-based models may also be used, where a generator network creates images, and a determinator network evaluates their realism, enabling the model to improve through adversarial training.

Image generation models may employ various training techniques, such as pixel-wise reconstruction or adversarial training, depending on the architecture. Pixel-wise reconstruction methods involve learning to reconstruct an image from its corrupted or downscaled version, optimizing the model to minimize the difference between the predicted and actual pixels (e.g., using mean squared error as the loss function). Adversarial training, often used with GANs, involves iteratively improving the generator network to produce images that are increasingly indistinguishable from real images, based on feedback from the determinator network. These approaches allow the model to capture complex visual features, enabling applications such as image synthesis, enhancement, and style transfer.

For video generation models, the model training engine 306 may employ transformer-based architectures like Video Transformers or GAN-based models specifically designed for handling temporal sequences. Video Transformers use self-attention mechanisms to model dependencies not only between pixels within a single frame but also across frames, allowing them to understand temporal relationships and motion patterns in videos. The model may be trained on large video datasets, enabling it to learn and reproduce dynamic changes and interactions between objects over time. GAN-based video models may incorporate spatiotemporal networks to evaluate the realism of generated video sequences, optimizing the model to produce continuous and coherent frames.

Video generation models may utilize spatial-temporal modeling techniques or adversarial training for generating realistic motion and video sequences. Spatial-temporal modeling involves learning the spatial features within each frame while simultaneously capturing the temporal dependencies between frames, optimizing the model's ability to predict future frames or complete missing sequences. Loss functions like mean squared error or perceptual loss may be applied to reduce discrepancies between predicted and actual frames. Adversarial training, on the other hand, may involve a generator creating video sequences and a determinator evaluating their realism, encouraging the generator to improve by minimizing the discrepancy identified by the determinator. These techniques may enable video generation models to create coherent and realistic sequences, useful in applications such as video synthesis and animation.

In audio generation models, the model training engine 306 may utilize architectures such as Audio Transformers or recurrent neural networks (RNNs) like WaveNet, designed to handle sequential and waveform data. Audio Transformers leverage attention mechanisms to capture relationships between segments of audio, allowing them to model temporal dependencies and predict the next audio sample based on previous context. During training, the model may process large audio datasets containing diverse sound patterns to learn representations of different audio features, such as frequency, amplitude, and harmonics. This training enables the model to generate coherent audio sequences, including speech, music, or ambient sounds, by synthesizing these learned patterns.

Audio generation models may be trained using sequence modeling techniques or autoregressive methods, depending on the architecture. Sequence modeling techniques involve processing and predicting sequences of audio samples, optimizing the model to capture and reproduce temporal dependencies in sound. Autoregressive methods, such as those employed in WaveNet, focus on predicting each audio sample based on prior samples, progressively refining the generated audio sequence over multiple iterations. Loss functions like mean absolute error or cross-entropy loss may be used to minimize the error between predicted and actual audio samples, guiding the model to improve its accuracy. These approaches allow audio generation models to create continuous and realistic audio outputs, applicable in areas such as speech synthesis, music generation, and sound effect creation.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 306 may implement optimization techniques such as gradient clipping, learning rate scheduling, and mixed-precision training. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In some implementations, the model training engine 306 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 306 may also support distributed training across multiple computing nodes, allowing the system to scale its computational resources as needed. Distributed training may involve splitting the generative AI model and data across multiple machines or GPUs, where each node processes a portion of the data and updates the model in parallel. This may be particularly useful for large datasets or models that require significant computational power, such as deep generative models. The model training engine 306 may synchronize the updates across the nodes using techniques like synchronous or asynchronous gradient descent.

Once the generative AI model is trained, the model training engine 306 may save the final trained generative AI model in a persistent storage location for future use. In specific implementations, metadata such as the number of epochs, the final loss values, and values of learned parameters may be logged for model versioning and/or retraining at a later stage. In some implementations, the model training engine 306 may also implement transfer learning, where a pre-trained model may be fine-tuned on a smaller, domain-specific dataset. This may reduce the amount of time and data required to train a new model, especially in cases where the available data may be limited or highly specialized. The model training engine 306 may adjust the parameters of the pre-trained model to better align with the new dataset, while preserving the learned features from the original training.

In implementations involving LLMs, new output may be generated by sampling from the model's probability distribution of tokens, conditioned on the context provided as input. Transformer-based architectures, such as GPT, use an auto-regressive approach where the model predicts the next token in a sequence one step at a time, using previously generated tokens as input for subsequent predictions. The process starts with a prompt or an initial sequence of words, and the model iteratively generates new tokens, forming coherent sentences or paragraphs based on the learned context and language patterns. For masked-language modeling (e.g., BERT), new output may be generated by filling in masked parts of the input sequence, allowing the model to complete sentences or generate variations of the provided text. The generated output can be controlled by adjusting parameters which influence the randomness of the token sampling, enabling the generation of diverse or deterministic responses.

In image generation models, such as those using ViTs or GANs, new output may be generated by sampling from the learned distribution in the model's latent space. For GANs, the generator network creates an image by transforming random noise vectors into structured image outputs through a series of layers that learn visual features like shapes, textures, and colors. The generated image may be then refined through adversarial feedback from the determinator network, which assesses the realism of the generated output. For transformer-based image models, the process may involve reconstructing images by assembling patches based on the learned dependencies between them. Input conditions, such as prompts describing desired features or specific noise vectors, guide the generation process, allowing for the creation of customized images or variations of existing visual styles. These models may also generate images based on style transfer techniques or predefined templates, synthesizing images that align with the characteristics present in the training data.

Video generation models utilize spatiotemporal dependencies to synthesize new video sequences based on the patterns learned during training. In transformer-based architectures, the model may generate video frames sequentially, predicting the next frame based on the input frames and the temporal context established by prior frames. GAN-based models, specifically designed for video synthesis, may sample noise vectors or use a sequence of frames as input, transforming these into continuous and temporally coherent video outputs through the generator network. The determinator evaluates the temporal consistency and realism of the output, ensuring the generated video mimics the motion dynamics and object interactions present in real-world video data. Such models may also use attention mechanisms to focus on critical elements within each frame and their evolution across time, facilitating realistic scene transitions and motion patterns. The generation process may include user-defined input such as initial frames, motion descriptions, or specific video attributes, providing control over the output.

Audio generation models, including Audio Transformers or autoregressive architectures like WaveNet, generate new audio sequences by predicting audio samples based on learned dependencies in sequential sound data. For autoregressive models, the generation process involves producing each audio sample one at a time, conditioned on previously generated samples, allowing the model to build complex audio patterns such as speech, music, or ambient sounds. The model starts with an initial segment or a random seed and uses its learned parameters to predict and synthesize subsequent samples, constructing a continuous audio waveform. Audio Transformers, on the other hand, may use attention mechanisms to identify important temporal segments within the input audio and synthesize new output based on these learned patterns. The user can control the type of audio generated by providing parameters such as pitch, tempo, or initial sound clips, enabling the model to generate outputs tailored to specific use cases like speech synthesis, music composition, or environmental sound generation.

In some implementations, generative AI models may also integrate multiple modalities, enabling cross-modal generation where output in one modality influences or conditions the generation in another. For example, a video generation model may use text descriptions as input, synthesizing video content that aligns with the specified narrative or visual scene described. Similarly, image generation models may generate visual representations based on audio inputs, such as generating animations synchronized to musical rhythms or speech patterns. These cross-modal systems typically involve conditional GANs or multi-modal transformers, where the model processes input from one domain (e.g., text or audio) and learns to generate output in another domain (e.g., video or image) by aligning the patterns and dependencies between the different modalities. These models may allow users to generate complex, multimodal content based on combinations of inputs, such as using textual prompts to control the visual and auditory elements of a video.

It will be understood that the implementation of the generative AI subsystem 300 illustrated in FIG. 3 is exemplary and that other implementations may vary. The generative AI subsystem 300, as well as its constituent elements, may vary, and modifications or alternative configurations may be implemented without departing from the broader scope of the disclosure. For instance, different machine learning algorithms, data sources, optimization techniques, or training methodologies may be employed depending on system requirements, application domain, and available computational resources. Furthermore, features and functionalities described in one implementation may be combined with those of another implementation as needed, and vice versa.

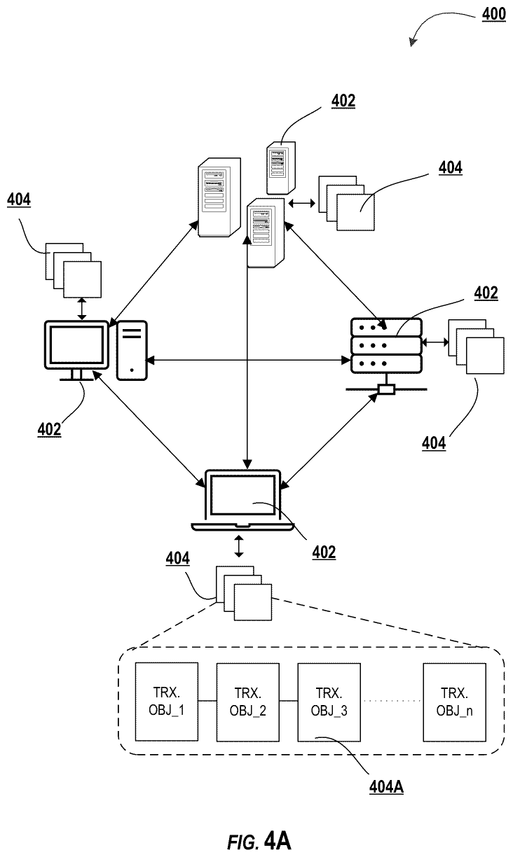

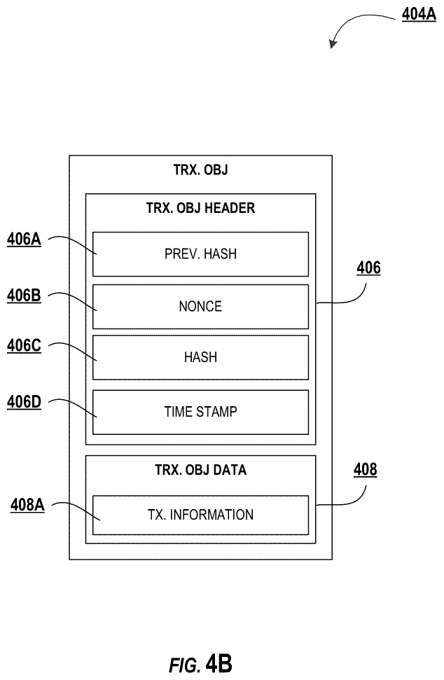

FIGS. 4A-4B illustrate an exemplary distributed ledger technology (DLT) architecture, in accordance with an implementation of the disclosure. DLT may refer to the protocols and supporting infrastructure that allow computing devices (peers) in different locations to propose and validate transactions and update records in a synchronized way across a network. Accordingly, DLT is based on a decentralized model, in which these peers collaborate and build trust over the network. To this end, DLT involves the use of potentially peer-to-peer protocol for a cryptographically secured distributed ledger of transactions represented as transaction objects that are linked. As transaction objects each contain information about the transaction object previous to it, they are linked with each additional transaction object, reinforcing the ones before it. Therefore, distributed ledgers are resistant to modification of their data because once recorded, the data in any given transaction object cannot be altered retroactively without altering all subsequent transaction objects.

To permit transactions and agreements to be carried out among various peers without the need for a central authority or external enforcement mechanism, DLT uses smart contracts. Smart contracts are computer code that automatically executes all or parts of an agreement and is stored on a DLT platform. The code can either be the sole manifestation of the agreement between the parties or might complement a traditional text-based contract and execute certain provisions, such as transferring funds from Party A to Party B. The code itself is replicated across multiple nodes (peers) and, therefore, benefits from the security, permanence, and immutability that a distributed ledger offers. That replication also means that as each new transaction object is added to the distributed ledger, the code is, in effect, executed. If the parties have indicated, by initiating a transaction, that certain parameters have been met, the code will execute the step triggered by those parameters. If no such transaction has been initiated, the code will not take any steps.

Various other specific-purpose implementations of distributed ledgers have been developed. These include distributed domain name management, decentralized crowd-funding, synchronous/asynchronous communication, decentralized real-time ride sharing and even a general purpose deployment of decentralized applications. In some implementations, a distributed ledger may be characterized as a public distributed ledger, a consortium distributed ledger, or a private distributed ledger. A public distributed ledger is a distributed ledger that anyone in the world can read, anyone in the world can send transactions to and expect to see them included if they are valid, and anyone in the world can participate in the consensus process for determining which transaction objects get added to the distributed ledger and what the current state each transaction object is. A public distributed ledger is generally considered to be fully decentralized. On the other hand, fully private distributed ledger is a distributed ledger whereby permissions are kept centralized with one entity. The permissions may be public or restricted to an arbitrary extent. And lastly, a consortium distributed ledger is a distributed ledger where the consensus process is controlled by a pre-selected set of nodes; for example, a distributed ledger may be associated with a number of member institutions (say 15), each of which operate in such a way that the at least 10 members must sign every transaction object in order for the transaction object to be valid. The right to read such a distributed ledger may be public or restricted to the participants. These distributed ledgers may be considered partially decentralized.

As shown in FIG. 4A, the exemplary DLT architecture 400 includes a distributed ledger 404 being maintained on multiple devices (nodes) 402 that are authorized to keep track of the distributed ledger 404. For example, these nodes 402 may be computing devices such as system 130 and client device(s) 140. One node 402 in the DLT architecture 400 may have a complete or partial copy of the entire distributed ledger 404 or set of transactions and/or transaction objects 404A on the distributed ledger 404. Transactions are initiated at a node and communicated to the various nodes in the DLT architecture. Any of the nodes can validate a transaction, record the transaction to its copy of the distributed ledger, and/or broadcast the transaction, its validation (in the form of a transaction object) and/or other data to other nodes.

As shown in FIG. 4B, an exemplary transaction object 404A may include a transaction header 406 and a transaction object data 408. The transaction header 406 may include a cryptographic hash of the previous transaction object 406A, a nonce 406B-a randomly generated 32-bit whole number when the transaction object is created, cryptographic hash of the current transaction object 406C wedded to the nonce 406B, and a time stamp 406D. The transaction object data 408 may include transaction information 408A being recorded. Once the transaction object 404A is generated, the transaction information 408A is considered signed and forever tied to its nonce 406B and hash 406C. Once generated, the transaction object 404A is then deployed on the distributed ledger 404. At this time, a distributed ledger address is generated for the transaction object 404A, i.e., an indication of where it is located on the distributed ledger 404 and captured for recording purposes. Once deployed, the transaction information 408A is considered recorded in the distributed ledger 404.

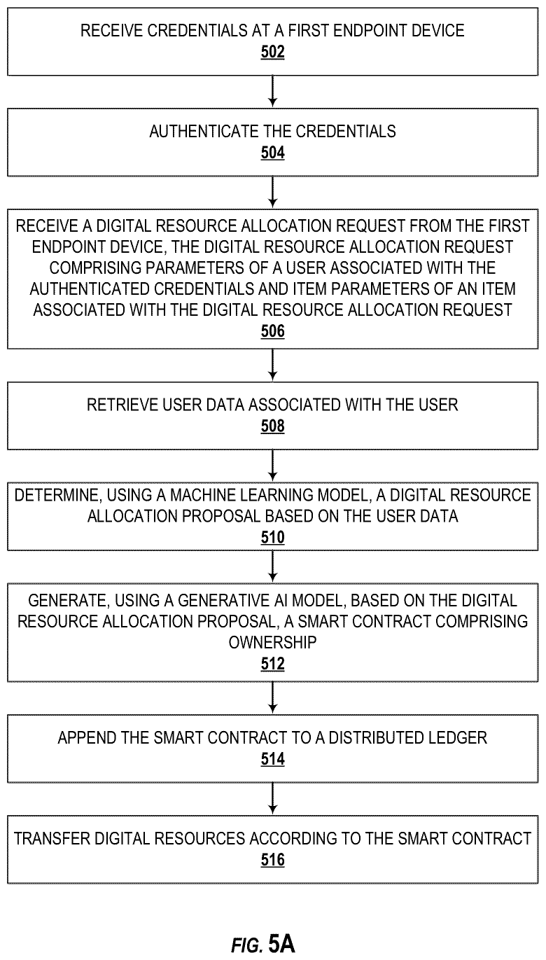

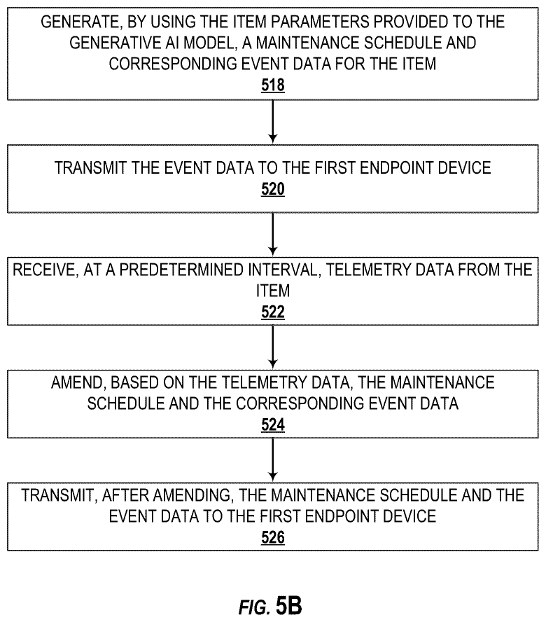

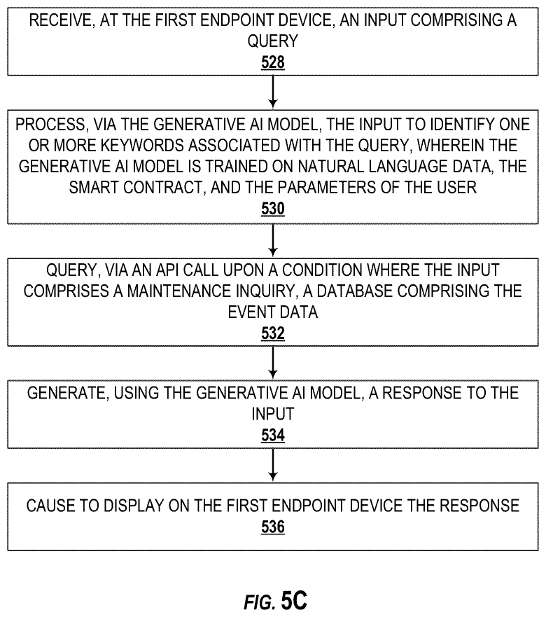

FIGS. 5A-5C illustrate a process flow for digital resource allocation via an interactive computational framework, in accordance with an implementation of the disclosure. At block 502, the system 130 may receive credentials at a first endpoint device 140. As used herein, “credentials” or “authentication credentials” may be any information that can be used to identify of a user. For example, the system or an endpoint device may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with an endpoint device.

Next, at block 504, the system 130 may authenticate the credentials. The authentication information may be used to authenticate the identity of the user (e.g., determine that the authentication information is associated with the account) and determine that the user has authority to access an account or system. In some implementations, the system 130 may be owned or operated by an entity. In such implementations, the entity may employ additional computer systems, such as authentication servers, to validate and certify resources inputted by the plurality of users within the system 130. The system 130 may further use its authentication servers to certify the identity of users of the system 130, such that other users may verify the identity of the certified users. In some implementations, the entity may certify the identity of the users. Furthermore, authentication information or permission may be assigned to or required from a user, application, computing node, computing cluster, or the like to access stored data within at least a portion of the system 130.

Continuing at block 506, the system 130 may receive a digital resource allocation request from an endpoint device (e.g., a first endpoint device 140).

In implementations directed to a loan arrangement between a user and an entity, a “digital resource” may refer to monetary value, where the monetary value is represented in digital form. This digital resource may constitute a form of currency or credit that exists within the entity's system 130 and is available for allocation to users. In implementations directed to lease arrangements for items, the “digital resource” that may be transferred to the user may simply be the lease agreement itself, typically with no monetary value exchanged from the entity to the user.

As used herein, a “digital resource allocation” may refer to a structured arrangement between a user and an entity (i) wherein the entity grants the user digital resources in exchange for an interest in an underlying item, or (ii) wherein the user agrees to make regular digital resource transfers in exchange for the right to use an item during a predetermine term while the entity retains ownership of the item. In other words, this digital resource allocation may take the form of a loan or lease. The digital resource allocation may be governed by predefined terms and conditions, for example, that allow the user to utilize the item in a certain manner, or, in instances where the digital resource allocation is a lease agreement, may allow the user to use the item for a specified duration. Upon the user agreeing to a digital resource allocation, particularly when such an allocation constitutes a loan, the entity may provide the user with digital resources, enabling the user to access the specified amount of money digitally for a designated purpose under agreed-upon terms and conditions.

As used herein, an “item” may refer to any physical property or resource tied to or underlying the digital resource allocation. Indeed, as used herein, an “item” may refer to any physical item or property, including but not limited to automobiles, motorcycles, boats, and similar vehicles. Such items are characterized by their tangible nature and their capacity to be owned, transferred, leased, or otherwise utilized under contractual agreements.

A digital resource allocation “request” may refer to the information provided associated with a user and/or the item subject to the digital resource allocation in order to request a formal agreement between the entity and the user regarding the item (e.g., to loan or lease the item). The digital resource allocation request may be received through a portal.

As used herein, a “portal” may refer to a website or application containing interactive elements, where the portal is accessible and may be interacted with by a user through a browser or application on a user interface of an endpoint device 140, and which may be operatively coupled to the system 130 described herein. Additionally, or alternatively, the portal may be a standalone application executed on an endpoint device 140, which may be interacted with by a user through the endpoint device 140, where the application is operatively coupled to the system 130 described herein.

The digital resource allocation request may include parameters of a user associated with the authentication credentials that were authenticated at block 504. Parameters of the user associated with the authentication credentials may include, for example, a user identifier, name, address, birth date, identification numbers, account details (e.g., how many accounts the user is in possession of), outstanding digital resource allocations associated with the user, or the like. In some implementations, the parameters of the user associated with the authentication credentials may be provided by the user who is completing the digital resource allocation request. In other implementations, the parameters of the user associated with the authentication credentials may be automatically populated by retrieving data associated with the authentication credentials from a database (e.g., by reverse lookup of tagging, metadata, or querying using other data organization methods).

The digital resource allocation request may also include item parameters of the item associated with the digital resource allocation request. This may include a make, model, production year, mileage, MSRP value, sales price, estimated use (e.g., anticipated number or limit of miles per predetermined time period), a listing of safety features of the item, or the like.

While the parameters of the user associated with the authentication credentials may provide some information regarding the user and assist in determining the details of the digital resource allocation (and/or request therefore), it shall be appreciated that such historical information may not fully capture the ability of the user to fulfill digital resource obligations that are undertaken as a result of agreeing to a digital resource allocation. Indeed, numerous other factors are desired to be considered such as to provide a comprehensive assessment of the user. Accordingly, the process may continue at block 508, where the system 130 retrieves user data associated with the user.

In some implementations, the user data associated with the user may include social media marketplace activity. It shall be appreciated that economic activity associated with a user may provide an indication of earnings and/or expenses that may not otherwise be accounted for through traditional analysis of ledgers of accounts associated with the user. For example, a user who has a large cashflow may receive a lower interest rate or monthly payment, as determined by the aggregate of sales on an online marketplace.

As such, the system 130 may retrieve data regarding the user's activity within an online marketplace of a predetermined social media website using one or more mechanisms depending on the website's architecture. For example, one method may be through through an API (Application Programming Interface), where the website provides interfaces that allow the system 130 to request and retrieve user activity data programmatically. This may include use of RESTful or use other protocols like GraphQL and may require authentication tokens provided by the user's completion of log-in information to access user-specific information securely. Additionally, or alternatively, the system 130 may implement webhooks, where the website automatically sends data when certain user activities occur, such as making a sale or a purchase. Additionally, or alternatively, scraping tools may be used if APIs or webhooks are not available.

Additionally, or alternatively, the user data associated with the user may include user account data. The account data may include records of transactions to and from an account of the user, current balances, statistics such as number of account deficit withdrawals, frequency of large transactions, or the like. For example, a user with a large balance in an account may result in a lower interest rate.

Additionally, or alternatively, the user data associated with the user may include employment history from a background check API. Indeed, the continuity of employment may be taken into consideration when determining the characteristics (e.g., amount, interest rate, time period) of a digital resource allocation proposal. For example, continuous employment over a given time period may reduce the payback interest rate of the digital resource allocation, whereas frequent unemployment over a given time period may increase the payback interest rate.

A background check service provider may provide an API through which the service provider provides an interface for allowing the requesting a retrieval of employment records. In some implementations, this may include use of RESTful or use other protocols like GraphQL and may require authentication tokens provided by the user's completion of log-in information, or personal identifiers, to access user-specific information securely.

Additionally, or alternatively, the user data associated with the user may include a collateral value assessment. Indeed, it shall be appreciated that the value of collateral (e.g., other items) owned by the user may be taken into consideration when determining the characteristics of the digital resource allocation proposal. For example, a user with otherwise unfavorable digital resource allocation history may own significantly valuable collateral. Thus, extending a digital resource allocation request to such a user may carry more favorable terms (i.e., characteristics) than that which would be extended to a user with unfavorable digital resource allocation history and little or no valuable collateral.

In some implementations, details regarding the collateral may be provided by the user. In other implementations, details regarding the collateral may be retrieved based on the associations between the user and real estate in the entity system 130 (e.g., the entity may hold a mortgage on the user's home).

In either implementation, the system 130 may query, using said details, valuation databases to determine the value of the collateral, thus forming the collateral value assessment. For example, a database may be maintained by a third party that lists real estate valuation estimated based on the property details (e.g., location, square footage, or the like). The database may provide an API through which the system 130 can query a valuation estimate of real estate, provided it has been provided by the user as collateral information. Similar databases, either through the same third party or other third parties may provide for collateral value assessment of vehicles, land, jewelry, other items, or the like.

Next, at block 510, the system 130 may determine, using a machine learning model 232, a digital resource allocation proposal based on the user data. The digital resource allocation “proposal” represents a proposed agreement to loan digital resources to, or lease an item to, a user. The digital resource allocation proposal may contain terms such as the digital resource allocation amount, interest rate (e.g., for repayment), time period of the repayment, lease term, monthly payments, or the like. Any and all of these terms may vary depending on the user data identified in block 508, the nature of the item, or the like.

Accordingly, yhe machine learning model 232 may be trained to determine the terms of the digital resource allocation proposal. The training process may begin with data collection and preparation. Factors such as social media marketplace activity, user account data, employment history from a background check API, collateral value assessment, or the like, may be quantified in a way that captures each's individual characteristics. The characteristics of each factor may be represented as numerical values or categorical data, depending on their nature. A dataset may be created where the factors are combined with their corresponding terms of the digital resource allocation proposal, will be used to train the model.

The next step may include defining the target term variable, which may be the digital resource allocation amount, interest rate, time period of the repayment, or the like, assigned to the group of factors. The model will learn the relationship between the input factors and the target term variable based on historical data. This data may include many examples where the factors are associated with known terms of the digital resource allocation proposal, so the model can learn to generalize from these patterns. The weighting of factors can either be part of the data or included as additional input features to help the model understand how the factors should contribute differently to the terms of the digital resource allocation proposal.

To train the machine learning model, the dataset may be split into training and testing sets. The training set may be used to teach the model, and the testing set will help evaluate its performance. A supervised learning algorithm, such as linear regression, decision trees, or neural networks, can be used, depending on the complexity and nature of the relationships between the factors and the score. The model will process the input data and adjust its internal parameters to minimize the error between the predicted terms of the digital resource allocation proposal and the actual terms of the digital resource allocation proposal during the training phase.

Once the model is trained, it will be able to take new factors such as social media marketplace activity, user account data, employment history from a background check API, collateral value assessment, or the like, as input and output terms of a digital resource allocation proposal, based on the learned relationships and weightings. To improve the model's accuracy, further fine-tuning of the machine learning model 232 may include techniques like cross-validation, hyperparameter tuning, or incorporating more sophisticated models that capture complex interactions between the factors.

In some implementations, once the digital resource allocation proposal has been determined by the machine learning model 232, the terms thereof may be transmitted to the endpoint device (e.g., the first endpoint device 140) and displayed to the user for acceptance or rejection by interacting with corresponding interactive elements (e.g., buttons) on the user interface. An acceptance may allow for the process to proceed as discussed below. However, a rejection may halt the process and redirect the digital resource allocation proposal to an endpoint device 140 of a user associated with the entity (e.g., an underwriter) for scrutiny and potential modifications thereto, before re-routing the digital resource allocation proposal back to the first endpoint device 140. In this way, any oversights or incorrect or unfavorable terms may be amended.

At block 512, the system 130 may generate a smart contract using a generative AI model. The smart contract may memorialize the accepted digital resource allocation proposal and record it in an immutable format or format otherwise conducive to recording changes to the smart contract. To do so, the smart contact may be generated for purposes of appending the smart contract to a distributed ledger. The smart contract may include information regarding ownership of the item, any liens or encumbrances on the item, identification of the item (VIN number, license plate number, description, make and model, etc.), and so forth, and may integrate the terms of the digital resource allocation proposal therein.

The smart contract may include code, generated by the generative AI model, that defines the terms of the accepted digital resource allocation proposal and the conditions that trigger specific actions. The generated portions of the smart contract may specify the participants (e.g., the user and the entity), and any other involved parties. The generated portions of the smart contract may declare variables to store contract-related data such as account balances, timestamps, item information, any or all of the terms of the digital resource allocation, and so forth. In some implementations, events may be incorporated to emit notifications when predetermined actions occur, for example notifying the user of the decommissioning of an item upon one or more payments not being made.

At block 514, the smart contract may be appended to a distributed ledger. In some implementations, the smart contract may be embedded directly into a transaction that is propagated through the distributed network. Upon validation, the smart contract may be stored in the blockchain's state and be permanently associated with a specific block. Alternatively, the smart contract may only be appended after a predefined number of participants sign off on its deployment using a multi-signature scheme. This ensures decentralized agreement before the contract is included in the distributed ledger, and validation occurs once the required signatures are collected. In other implementations, the smart contract is encapsulated as a non-fungible token (NFT) or unique digital item. The NFT may be appended to the distributed ledger, and interactions with the contract occur by referencing the token on-chain.

In some implementations, the smart contract may include a maintenance record of the item. This maintenance record may include descriptions for the type of maintenance (i.e., maintenance item) to be performed, and the mileage of the item after which the maintenance item is to be performed. When an event occurs (e.g., a predetermined number of miles have been travelled in the item, a maintenance task has been completed, etc.), a transaction may be submitted to the network, invoking a function within the smart contract that updates the maintenance record. This updated state may then be reflected on the distributed ledger to ensure that all participants have access to the maintenance record.

Additionally, or alternatively, in some implementations, the smart contract may include an accident history. The accident history may be an accident record including information about the time and/or place of damage to the item, a description of the damaged areas, costs associated with repairing the damage, whether or not the repairs have been completed, and so forth. When an event occurs (e.g., a recorded incident involving the item, a surrendering of the item to a qualified repair shop, etc.), a transaction may be submitted to the network, invoking a function within the smart contract that updates the accident history. This updated state may then be reflected on the distributed ledger to ensure that all participants have access to the accident record.

Next, at block 516, and specifically for implementations where the digital resource allocation comprises a loan, the system 130 may transfer digital resources according to the smart contract. The smart contract may include the amount of digital resources (either in FIAT currency or cryptocurrency), party or parties involved in the digital resource allocation, time of the transferring of the digital resources, location (e.g., geolocation coordinates) of the transferring of the digital resource, etc. In accordance with these specifications of the smart contract, the digital resources may be dispersed to the recipient. In some implementations, the smart contract may include an address (e.g., crypto address associated with a specific user or wallet) or other identifier of the party that is the recipient of the digital resources and/or the sender of the digital resources, such that upon execution of the smart contract, the digital resources are automatically dispersed from one party to the recipient.

In some implementations, the process may continue at block 518 of FIG. 5B. At block 518, the system 130 (e.g., the generative AI model) may generate a maintenance schedule. To do so, the generative AI model may be provided with the item parameters, including but not limited to: make, model, year of manufacture, mileage, average number of miles used (i.e., a mileage rate, or a predetermined number of miles provided as an estimate or a maximum limit) per predetermined time period, a recommended maintenance schedule provided by the manufacturer of the item, and so forth. Using this information, in conjunction with the mileage rate, a time estimate before a subsequent maintenance event is to occur (i.e., a date of a maintenance event) may be determined. Additionally, further subsequent maintenance events may be determined by projecting the subsequent dates based on the milage rate.

From these maintenance events, the maintenance schedule may be developed, which may list one or more maintenance events and their projected dates of need (e.g., when a certain number of miles on the item is projected to be met, or when a certain duration of time has passed). The maintenance schedule may be transformed into calendar entries in the form of event data for the item, which may be caused to be displayed, via the portal, on the first endpoint device 140.

In some implementations, the event data may take the form of. ics or other calendar filetypes that may be able to be amended, shared with others, accepted and rejected, or the like. Accordingly, at block 520, the system 130 may transmit the event data to the first endpoint device 140 in such a format via email, direct messaging, or any other communication protocols. Additionally, or alternatively, the event data may be transmitted in such a manner to an endpoint device 140 associated with a maintenance service provider. In this way, an appointment for a maintenance event (i.e., a service appointment for the item) may be confirmed and automatically scheduled between the maintenance service provider and the user.

Continuing at block 522, the system 130 may receive, at a predetermined interval, telemetry data from the item. Telemetry data, such as mileage and locations traveled, may be received by the system 130 from an item through mechanisms, such as the item transmitting telemetry data (e.g., mileage, routes travelled from a GPS module that collects GPS coordinates at a predetermined interval or constantly) via cellular networks in operable communication with the system 130 at a predetermined interval, by utilizing an onboard telematics unit that collects and relays information in real-time to one or more remote servers of the system 130. Additionally, or alternatively, the data may be transmitted at a predetermined interval via satellite communication, such as in areas lacking cellular network availability. Additionally, or alternatively, the item may communicate with external systems at a predetermined interval via short-range wireless protocols, such as Bluetooth or Wi-Fi, where data is offloaded when in proximity to a receiver, such as a home or fleet hub. Additionally, or alternatively, a direct connection through a wired interface, such as a USB or onboard diagnostics port, may allow for manual data extraction at predetermined intervals.

Next, at block 524, the system 130 may amend the maintenance schedule and the corresponding event data based on the telemetry data received at block 522. It shall be appreciated that, while an initial estimate of the mileage rate of the item may be provided prior to the digital resource allocation, circumstances may lead to less use or more use of the item. In doing so, the maintenance schedule for the item may need to be amended to provide for the maintenance service to occur at the prescribed time or prescribed milage.

To do so, the system 130 may, using the telemetry data received, re-forecast (i.e., re-project) a time estimate before a subsequent maintenance event is to occur in a manner such as that which is described at block 520. Indeed, using the predetermined time interval of the collected telemetry data, along with the miles travelled within that predetermined time interval, the subsequent maintenance event(s) within the maintenance schedule may be shifted in time (forwards for the re-forecasted time estimate when more miles are travelled, backwards for the re-forecasted time estimate when fewer miles are travelled).

At block 526 the system 130 may transmit, after amending the maintenance schedule in accordance with block 524, the (amended) maintenance schedule and the corresponding event data to the first endpoint device 140. In this way, when viewing the portal on the first endpoint device 140, or when viewing a 3^{rd} party calendar application that receives event data, the user may have the most up-to-date maintenance schedule and appointments for service in accordance with the maintenance schedule.

Additionally, or alternatively, the event data corresponding to the amended maintenance schedule may be transmitted to an endpoint device 140 associated with a maintenance service provider. In this way, an appointment for a maintenance event (i.e., a service appointment for the item) may be updated at the maintenance service provider and/or confirmed and automatically scheduled between the maintenance service provider and the user.

In some implementations, the process may continue at block 528 of FIG. 5C. At block 528, the system 130 may receive, at the first endpoint device 140, an input including a query. Indeed, a user, in interacting with an endpoint device 140, may have questions or other inquiries regarding the digital resource allocation. For example, a user may inquire about the remaining length of the digital resource allocation, the interest rate, a lease payment amount, a digital resource allocation repayment amount, the date(s) and time(s) of upcoming maintenance event(s), location of upcoming maintenance event(s), or the like.

To do so, the portal displayed on the user interface of the first endpoint device 140 may include an interaction element for receiving a text query (e.g., a text box) as an input. Upon entering the query, the query (i.e., input) may be processed via the generative AI model, as illustrated at block 520. The generative AI model may identify one or more keywords within (i.e., associated with) the query. As the generative AI model has been trained on natural language data, these keywords may be identified, to gather a contextual understanding of the query, and what the user is interested in seeing in a response to the query.

In some implementations, the generative AI model may also be trained on the smart contract and the parameters of the user. In such implementations, the generative AI model may be trained on datasets comprising the smart contract and the parameters of the user, to enable the generative AI model to produce outputs based on patterns and relationships learned from both the smart contract and the parameters of the user during training. Additionally, or alternatively, the generative AI model may be provided with the smart contract and/or the parameters of the user at the time of query input, to allow the model to directly utilize the smart contract and/or the parameters of the user as part of its response generation process without relying solely on pre-existing training data. In such implementations, the query input may be processed in conjunction with the provided the smart contract and/or the parameters of the user, to ensure that the output (i.e., the response to the query) is tailored to the input in view of the smart contract and the parameters of the user.

In some implementations, the query provided to the generative AI model may include an input having a maintenance inquiry. In other words, a user may have questions about the maintenance schedule of their item. Accordingly, at block 532, the system 130 may query, via an API call, a database including the event data (e.g., maintenance service appointments). This may be beneficial for providing accessibility to the event data via the generative AI model, regardless of whether the portal at the first endpoint device 140 or other third-party application contains this information.

Next, at block 534, the system 130 may generate, using the generative AI model, a response to the input. The generative AI model may form a response based on the query by processing the input through a series of layers (e.g., neural network layers) that have been trained to recognize and generate patterns. Upon receiving the query, the model may first tokenize the input and break it down into smaller units that can be understood by the system 130. These tokens may then be passed through an embedding layer, which converts them into numerical vectors representing their semantic meaning. The generative AI model may apply attention mechanisms to focus on relevant parts of the input, determining the contextual relationships between tokens. Utilizing its trained weights and parameters, the model may then generate predictions for each next token, iteratively constructing the output sequence based on the query's context, until a contextually appropriate response is formed.

Continuing at block 536, the system 130 may cause to display on the first endpoint device 140 the response generated in block 534. In some implementations, the generative AI model may allow for subsequent questions within a persistent “conversation” between the user and the generative AI model, which allows for refinement and clarification of initial queries, leading to more precise and contextually relevant responses.

As will be appreciated by one of ordinary skill in the art, the present disclosure may be implemented as an apparatus (including, for example, a system, a machine, a device, a computer program product, and/or the like), as a method (including, for example, an enterprise process, a computer-implemented process, and/or the like), as a computer program product (including firmware, resident software, micro-code, and the like), or as any combination of the foregoing. Many modifications and other implementations of the present disclosure set forth herein will come to mind to one skilled in the art to which these implementations pertain having the benefit of the teachings presented in the foregoing descriptions and the associated drawings. Although the Figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for digital resource allocation via an interactive computational framework, the system comprising:
a processing device; and
a non-transitory storage device containing instructions, when executed by the processing device, the instructions cause the processing device to perform the steps of:
receiving credentials at a first endpoint device;
authenticating the credentials;
receiving a digital resource allocation request from the first endpoint device, the digital resource allocation request comprising parameters of a user associated with the authenticated credentials and item parameters of an item associated with the digital resource allocation request;
retrieving user data associated with the user;
determining, using a machine learning model, a digital resource allocation proposal based on the user data;
generating, using a generative AI model, based on the digital resource allocation proposal, a smart contract comprising ownership;
appending the smart contract to a distributed ledger; and
transferring digital resources according to the smart contract.

2. The system of claim 1, wherein the instructions further cause the processing device to perform the steps of:
generating, by using the item parameters provided to the generative AI model, a maintenance schedule and corresponding event data for the item;
transmitting the event data to the first endpoint device;
receiving, at a predetermined interval, telemetry data from the item;
amending, based on the telemetry data, the maintenance schedule and the corresponding event data; and
transmitting, after amending, the maintenance schedule and the event data to the first endpoint device.

3. The system of claim 2, wherein the instructions further cause the processing device to perform the steps of:
receiving, at the first endpoint device, an input comprising a query;
processing, via the generative AI model, the input to identify one or more keywords associated with the query, wherein the generative AI model is trained on natural language data, the smart contract, and the parameters of the user;
querying, via an API call upon a condition where the input comprises a maintenance inquiry, a database comprising the event data;
generating, using the generative AI model, a response to the input; and
causing to display on the first endpoint device the response.

4. The system of claim 1, wherein the user data associated with the user comprises parameters of the user selected from a group consisting of: the user data comprising social media marketplace activity, user account data, employment history from a background check API, and collateral value assessment.

5. The system of claim 1, wherein the digital resource allocation proposal based on the user data comprises a digital resource allocation amount, rate, and time period.

6. The system of claim 1, wherein the smart contract further comprises maintenance records.

7. The system of claim 1, wherein the smart contract further comprises an accident history.

8. A computer program product for digital resource allocation via an interactive computational framework, the computer program product comprising a non-transitory computer-readable medium comprising code causing an apparatus to:
receive credentials at a first endpoint device;
authenticate the credentials;
receive a digital resource allocation request from the first endpoint device, the digital resource allocation request comprising parameters of a user associated with the authenticated credentials and item parameters of an item associated with the digital resource allocation request;
retrieve user data associated with the user;
determine, using a machine learning model, a digital resource allocation proposal based on the user data;
generate, using a generative AI model, based on the digital resource allocation proposal, a smart contract comprising ownership;
append the smart contract to a distributed ledger; and
transfer digital resources according to the smart contract.

9. The computer program product of claim 8, wherein the code further causes the apparatus to:
generate, by using the item parameters provided to the generative AI model, a maintenance schedule and corresponding event data for the item;
transmit the event data to the first endpoint device;
receive, at a predetermined interval, telemetry data from the item;
amend, based on the telemetry data, the maintenance schedule and the corresponding event data; and
transmit, after amending, the maintenance schedule and the event data to the first endpoint device.

10. The computer program product of claim 9, wherein the code further causes the apparatus to:
receive, at the first endpoint device, an input comprising a query;
process, via the generative AI model, the input to identify one or more keywords associated with the query, wherein the generative AI model is trained on natural language data, the smart contract, and the parameters of the user;
query, via an API call upon a condition where the input comprises a maintenance inquiry, a database comprising the event data;
generate, using the generative AI model, a response to the input; and
cause to display on the first endpoint device the response.

11. The computer program product of claim 8, wherein the user data associated with the user comprises parameters of the user selected from a group consisting of: the user data comprising social media marketplace activity, user account data, employment history from a background check API, and collateral value assessment.

12. The computer program product of claim 8, wherein the digital resource allocation proposal based on the user data comprises a digital resource allocation amount, rate, and time period.

13. The computer program product of claim 8, wherein the smart contract further comprises maintenance records.

14. The computer program product of claim 8, wherein the smart contract further comprises an accident history.

15. A method for digital resource allocation via an interactive computational framework, the method comprising:
receiving credentials at a first endpoint device;
authenticating the credentials;
receiving a digital resource allocation request from the first endpoint device, the digital resource allocation request comprising parameters of a user associated with the authenticated credentials and item parameters of an item associated with the digital resource allocation request;
retrieving user data associated with the user;
determining, using a machine learning model, a digital resource allocation proposal based on the user data;
generating, using a generative AI model, based on the digital resource allocation proposal, a smart contract comprising ownership;
appending the smart contract to a distributed ledger; and
transferring digital resources according to the smart contract.

16. The method of claim 15, the method further comprising:
generating, by using the item parameters provided to the generative AI model, a maintenance schedule and corresponding event data for the item;
transmitting the event data to the first endpoint device;
receiving, at a predetermined interval, telemetry data from the item;
amending, based on the telemetry data, the maintenance schedule and the corresponding event data; and
transmitting, after amending, the maintenance schedule and the event data to the first endpoint device.

17. The method of claim 16, the method further comprising:
receiving, at the first endpoint device, an input comprising a query;
processing, via the generative AI model, the input to identify one or more keywords associated with the query, wherein the generative AI model is trained on natural language data, the smart contract, and the parameters of the user;
querying, via an API call upon a condition where the input comprises a maintenance inquiry, a database comprising the event data;
generating, using the generative AI model, a response to the input; and
causing to display on the first endpoint device the response.

18. The method of claim 15, wherein the user data associated with the user comprises parameters of the user selected from a group consisting of: the user data comprising social media marketplace activity, user account data, employment history from a background check API, and collateral value assessment.

19. The method of claim 15, wherein the digital resource allocation proposal based on the user data comprises a digital resource allocation amount, rate, and time period.

20. The method of claim 15, wherein the smart contract further comprises maintenance records.
